(19) United States
(12) Patent Application Publication
(10) Pub. No.: US 2011/0266078 A1
(43) Pub. Date: Nov. 3, 2011

(54) ORDER PICKING CART FOR STOCK CHASER VEHICLE

(75) Inventor: Peter P. Hupke, Delavan, IL (US)

(73) Assignee: Caterpillar Inc., Peoria, IL (US)

(21) Appl. No.: 12/771,381

(22) Filed: Apr. 30, 2010

(51) Int. Cl. B62D 53/04

(52) U.S. Cl. 180/14.1

(57) ABSTRACT

A material handling system with improved load handling and product distribution capabilities including, a stock chaser vehicle having a motorized truck portion, an operator platform, a load bearing deck portion having a front end and a rear end, and at least two wheels in a rear portion of the vehicle, wherein the deck portion is facing a load area; a picker cart removably coupled to the stock chaser vehicle, with the cart having a front and a rear end, and defining a volume above a portion of the vehicle deck for receiving objects picked by the operator, having four wheels each generally attached at one of the corresponding four corners of the cart; and, a coupling means for secure engagement of the picker cart to the stock chaser vehicle, whereby the picker cart and the stock chaser vehicle are aligned as to substantially share the same travel footprint.

### TECHNICAL FIELD

The present disclosure relates generally to stocker chaser vehicles, and more particularly to a material handling system including a removable freestanding order picking cart on which articles are loaded or from which they are distributed that operates in conjunction with an associated stock chaser vehicle whereby the cart is engaged with, coupled to and carried with the vehicle without any need for hydraulic mechanisms or their mechanical lever counterparts or equivalents.

### BACKGROUND

The day-to-day and hour-to-hour filling of orders from the stock shelves of warehouses and similar storage buildings or areas has long been a troublesome problem. Many and varied procedures and techniques have been employed, but none has proven completely satisfactory in all respects.

Stock chasers are vehicles used in warehouse and distribution environments to retrieve goods off shelves and bring them to another area. Stock chaser type vehicles have a long narrow platform in front of the driver for the placement of these items. The items are typically then moved off this platform to their subsequent destination; this involves handling the items multiple times. An improvement to this procedure is envisioned by using a cart that straddles the stock chaser and can be used in place of the platform for holding the items. Furthermore, the freestanding cart may also be used at the staging area for parts later in machine assembly lines, or for pre-loading before a pick up.

Stock chaser vehicles are used to retrieve products from shelves in order to fill a customer order or machine assembly line. The products are typically stored in a rack system in which a plurality of unit loads of many products are stored. Each unit load, generally, contains a single type of product and a customer or end user typically requires one or more boxes of product pieces from many different unit loads. This requires an operator to travel up and down one or more aisles of the rack system to pick products from many different locations in the rack system to fill the order.

Typically, each product picked by the operator is placed on the single, flat, load platform or deck fixed to the front of the vehicle. As the number of picked products increases, the operator stacks products on top of each other to build a load comprising the specific products ordered by the customer or needed at the machine assembly line. The stacked products increase the height of the load on the deck. As the height of the load on the deck increases, adding additional products to the top of the load becomes increasingly difficult for the operator. As the load height increase, the load can become unstable and fall off of the load platform or deck which may damage or destroy the product.

Once the operator arrives at a final delivery destination, the operator must dismount the vehicle and pick each individual piece of the load and replace it on the rack or shelves at the final locale. Additionally, the stock chaser vehicle is supported by ground engaging wheels that allow the vehicle to travel in aisles between rows of storage racks, generally maintaining a narrow footprint for optimal maneuvering through narrow rows or aisles of the warehouse.

In order to eliminate the time-consuming, extra part-handling step, a new shelved cart on the stock chaser is removably attached to the system. The cart may be removed as a separate unit at the final stop or pack area. The cart includes shelving that can be used as a manual cart and be attached to the stock chaser vehicle and shelving wheels that support the shelving while operating the stock chaser.

The stock chaser order-picking cart can be used by both the stock chaser operator and the person at the final stop or pack area. The ordered parts would only be touched when picked to the cart and when taken from the cart to be packed for shipping, on an as-needed basis, rather than as a required step in order to free the deck area of the stock chaser vehicle. When filling parts orders using a traditional stock chaser vehicle, the order picker would have to manually remove parts from the vehicle bed or shelves to drop areas at the final stop or pack areas. This extra handling of the parts causes wasted time and decrease quality due to lost and damaged parts.

Wasted time and retracing steps during part transport have long been known as a serious problem in logistics and warehousing operations. Further, a functional cart which can easily be joined to a vehicle with a load bed or deck which faces the loading area, thereby maintaining the same footprint as the vehicle, is needed.

U.S. Pat. No. 3,752,345, issued to Benedict Molis, attempts to overcome the problems described above by providing a motor-driven truck adapted for use as a prime mover and including means for engaging and for supporting and propelling an auxiliary conveyance such as a cart. The truck includes a frame-carried friction-reducing bed defining a support base for the cart bearing thereupon, and means for positioning the cart on the truck for transport thereby. The Molis invention suffers from at least one deficiency in that rails, guide bars, or longitudinally spaced rollers are required for stable lateral positioning or placement of the cart on the friction-reducing bed, which takes additional space, and significantly increases cost. Additionally, the footprint is greatly expanded with this configuration, which is particularly bothersome and undesired in a typical, tightly spaced warehouse or distribution center.

The present disclosure is directed to overcoming one or more of the problems set forth above.

### SUMMARY

In one aspect, the present disclosure is directed to a material handling system with improved load handling and product distribution capabilities including, a stock chaser vehicle having a motorized truck portion, an operator platform, a load bearing deck portion having a front end and a rear end, and at least two wheels in a rear portion of the vehicle, wherein the deck portion is facing a load area; a picker cart removably coupled to the stock chaser vehicle, with the cart having a front and a rear end, and defining a volume above a portion of the vehicle deck for receiving objects picked by the operator, having four wheels each generally attached at one of the corresponding four corners of the cart; and, a coupling means for secure engagement of the picker cart to the stock chaser vehicle, whereby the picker cart and the stock chaser vehicle are aligned as to substantially share the same travel footprint.

### BRIEF DESCRIPTION OF THE DRAWINGS

FIG. 1 is a perspective illustration of one embodiment of the present disclosure;

FIGS. 2A and 2B are side elevational views of the present disclosure in an engaged and disengaged state, respectively;

FIG. 3 is a front view of the system of the present disclosure; and,

FIG. 4 is a side elevational view showing an exemplary embodiment of the present disclosure, in an engaged state.

### DETAILED DESCRIPTION

Reference will now be made in detail to embodiments of the present disclosure, examples of which are illustrated in the accompanying drawings. Wherever possible, the same reference numbers will be used throughout the drawings to refer to the same or like parts.

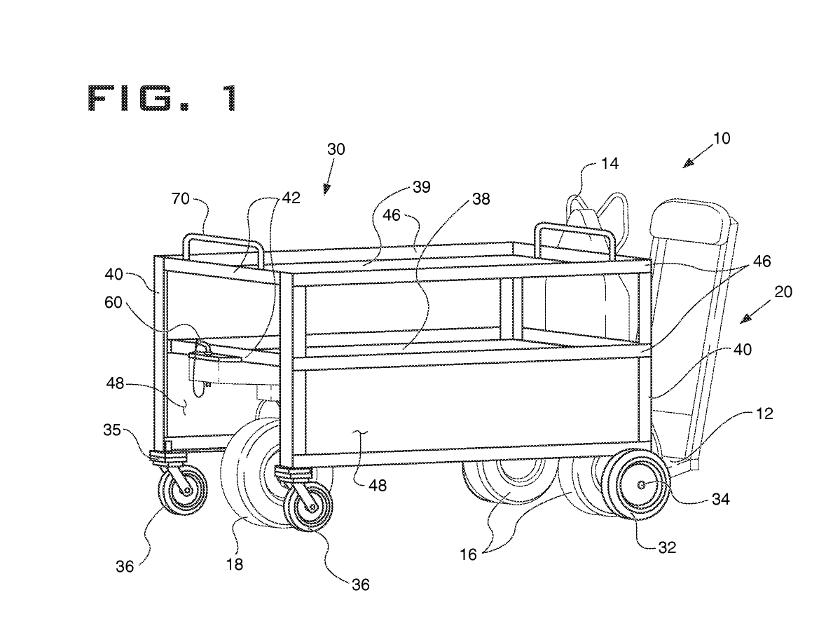

FIG. 1 illustrates an embodiment of a material handling system 10 of the present disclosure. As briefly described above, the present disclosure is directed to a material handling system 10 with a removable freestanding order picking cart 30 to provide an improved system of load handling and product distribution and collection. The cart 30 on which articles (not shown) are loaded or from which they are distributed operates in conjunction with low friction means carried by an associated stock chaser vehicle 20 whereby the cart 30 is automatically engaged with, coupled to and carried upon the truck without any need for hydraulic mechanisms or their mechanical lever counterparts or equivalents. The system 10 of the present disclosure combines a stock chaser type vehicle 20 generally including a motorized truck portion 11 having an operator platform 12 and a steering mechanism 14. On a typical stock chaser type vehicle 20, the motorized truck portion 11 has at least one steerable wheel means 18 at a front end thereof, and at least two non-steerable wheel means 16 at a rear end thereof, and includes a deck or load platform 22. The vehicle 20 may optionally be suited with self-adjusting drum brakes, a battery pack, and electronic speed controllers (not shown) for dependability, performance endurance and minimized operator fatigue.

Turning again to FIG. 1, the removable order picking cart 30 of the system 10 includes a front end and a rear end with two or more rotating wheels for turning in line with the direction of the stock chaser vehicle 20 and permitting easy steering of the cart as it is moved over a subjacent ground surface.

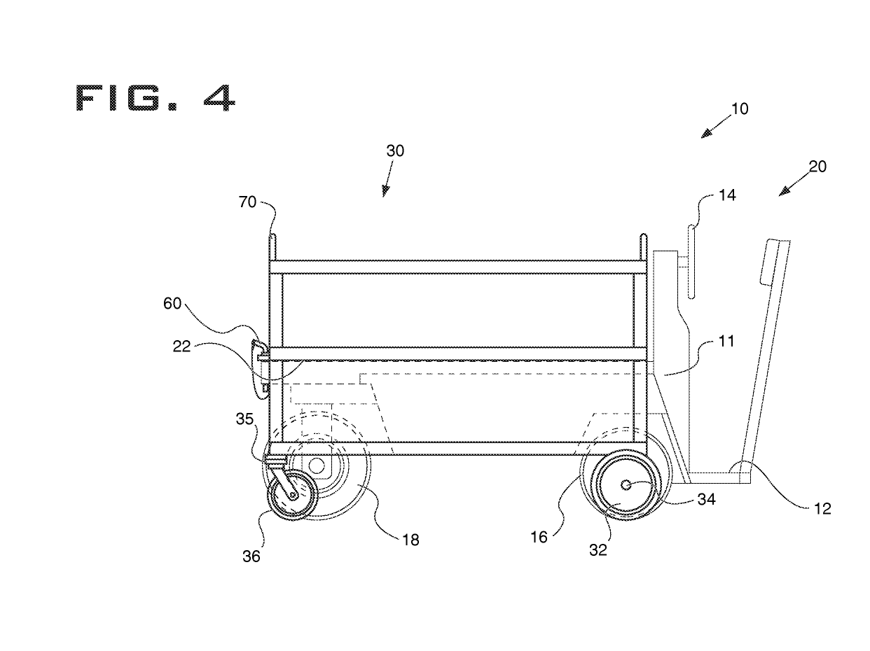

The removable cart 30 includes four wheels 32, 36, each of the four wheels being generally located near a corresponding one of the four corners of the cart 30. The embodiment (seen at FIG. 1 and FIG. 4) illustrates swivel wheels 36 at the front end, having axle supports 35 which are mounted to swivel-type casters on opposite sides of a front portion of the cart frame for rotation about a substantially vertical axis, and two wheels 32 having axle supports which are fixedly mounted to opposite sides of the rear end of the picker cart 30. The swivel wheels 36 facilitate steering of the cart when it is moved from one location to another. Non-steerable wheels 32 at a rear end of the cart 30 align preferably at the centerline, to the wheel means 16 at the rear end of the stock chaser vehicle 20, and having the same centerline axis of rotation 34 while in the engaged state. Each of the wheels may include a brake mechanism (not shown) to maintain the removable picker cart 30 in a stationary state at a desired location.

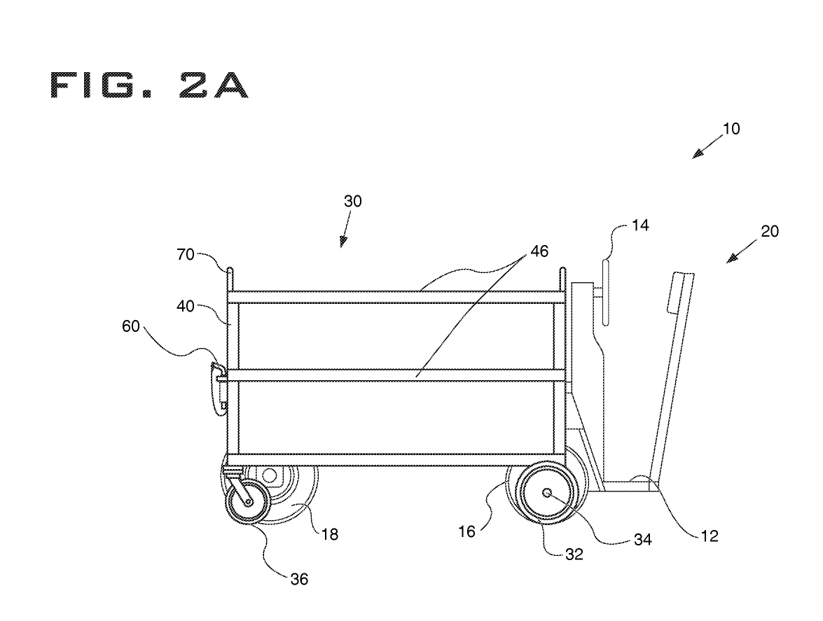

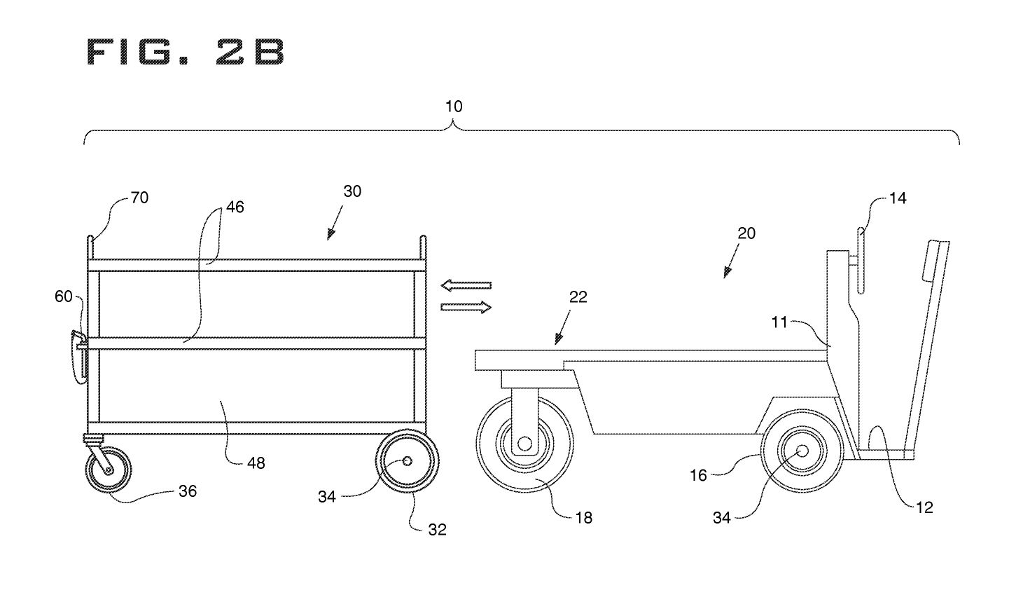

With reference now to FIGS. 2A and 2B, a side elevational view of the material handling system 10 is generally shown, highlighting a coupled relationship between the stock chaser vehicle 20 and the cart 30. During the course of a material distribution operation, an operator will typically start by engaging the cart 30 and stock chaser vehicle 20 by aligning the front end of the vehicle 20 with the rear end of the cart 30, pushing the cart 30 full straddle position over the stock chaser 20, and then securing the cart 30 to the vehicle 20 utilizing an engagement or coupling means 60. This arrangement provides essentially a single travel footprint for the cart and vehicle.

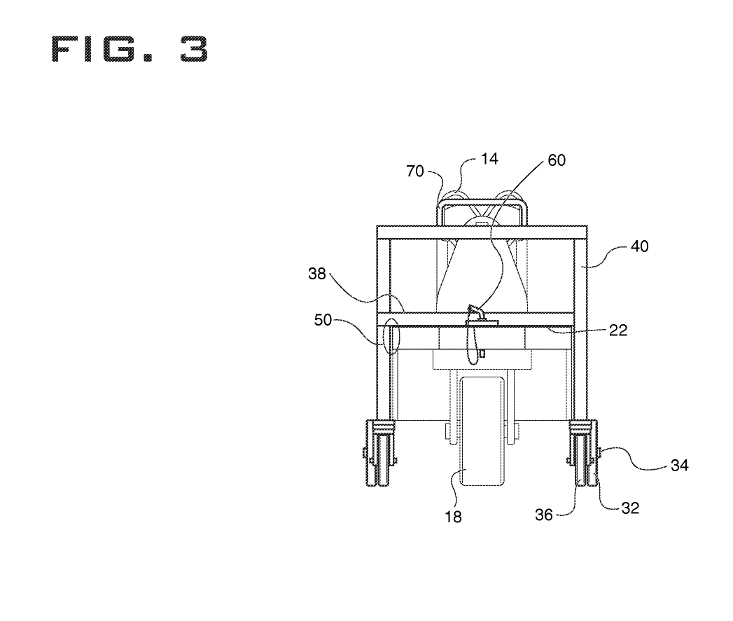

The engagement mean 60 components are located at the front ends of both the cart 30 and the chaser vehicle 20, and may include a pin securely attached to the cart 30 sized to fit securely into a related bore, or other hitch mechanism. The pin may be tapered, completely rounded, or possess any other mating geometry, as would be understood by one skilled in the art. In the present described disclosure, the coupling means 60 is shown as a 1″ diameter generally L-shaped pin inserted through a related bore, as seen in FIG. 3, in the stock chaser vehicle 20 to securely hold the cart 30 in place during travel.

As best exemplified in FIG. 3, when engaged, the total side-to-side clearance 50 between the removable cart 30 and the stock vehicle 20 is less than 1 inch, preferably at approximately 0.5 inches. This clearance dimension will allow the cart 30 to maintain its alignment during travel, and does not require hydraulic or expensive, advanced mechanical connections. Advantageously, the four wheels remain engaged with the ground, requiring no additional load to the vehicle deck 22 and allows for a single travel footprint, keeping the critical turning radius during travel throughout the often narrow warehouse distribution aisles, to a minimum. Essentially, no larger than the stock chaser vehicle's 20 footprint alone.

Further, the cart portion 30 of the material handling system 10 includes an outer frame member 40, whereby the outer frame 40 incorporates multiple shelving units 38, 39, and handle portion 70, and to which the wheel means 36, 32 connect. The shelving units 38, 39 of the cart portion 30 generally form at least one tray surface having a generally rectangular bottom and a peripheral wall attached to and extending upwardly therefrom, said peripheral wall comprising a front wall 42, a back wall 44, and a pair of side walls 46. Further, the outer frame member may preferably include an enclosed side panel portion 48 between the lower two side wall rails to protect the stock chaser vehicle 20 from debris or falling articles from the cart 30. The side panel 48 could be on one or both sides of the cart 30 as desired. As would be understood by one skilled in the art, the size or depth of the cart platforms 22 may be adjusted depending on the type of material being transported or shape and size of the parts. The disclosed assembly would be appropriate to numerous types of logistics and warehousing operations.

A handle portion 70 may be attached to a front end of the cart 30 to facilitate movement of the cart 30 from an engaged state to a disengaged or released state while incorporated with the material handling system 10. Additionally, a similar handle portion 70 may optionally be attached at a rear end. In a disengaged or released state, the handle portion may be utilized to maneuver the cart 30 manually to facilitate movement. Further, each of the wheels may include a brake mechanism (not shown) to maintain cart 30 in a stationary condition at a desired location.

Turning now to FIGS. 3 and 4, exemplary embodiments of the chaser vehicle 20 and cart portion 30 of the present disclosure are shown. The geometry and number of shelving surfaces 38, 39 are mere examples of the multifarious varieties available. Additionally, integrated containers or curved or magnetic racks may be used. A small stock part will lend itself to one variety of shelving unit, where as a larger or odd shaped part will lend itself to a totally different type cart shelf. All combinations of numbers or variety of shelving are contemplated with this present innovation.

Once an operator has arrived at an interim or final destination, the operator or another worker working at the destination can uncouple the engagement means 60, and use the handle 70 to remove the cart 30 from the chaser vehicle 20. Of course, other methods for removing the cart 20 from the chaser vehicle 10 can be used, such as by independently controlling the vehicle 10 and cart 20 using limit switches, encoders, and the like with controllers, without departing from the scope of the present disclosure.

### INDUSTRIAL APPLICABILITY

It will be seen that the present disclosure provides a material handling system 10 by which a removably attachable, freestanding order picking cart 30 provides an improved system of load handling and product distribution and collection. The cart 30 on which articles (not shown) are loaded or from which they are distributed operates in conjunction with low friction means carried by an associated stock chaser vehicle 20 whereby the cart 30 is automatically engaged with, coupled to and carried upon the truck without any need for hydraulic mechanisms or their mechanical lever counterparts or equivalents. Accordingly, the disclosed innovation may be seen as being an apparatus or combination for existing stock chaser or order picker vehicles to increase their productivity. However, the disclosure as defined by the appended claims is deemed to cover various modifications of the embodiments disclosed herein, according to the scope of the claims, which modifications are deemed covered as equivalent structures as will be apparent to those of ordinary skill in the machine tool art.

It will be appreciated that the foregoing description provides examples of the disclosed apparatus. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely, unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A material handling system with improved load handling and product distribution capabilities comprising:
a stock chaser vehicle including a motorized truck portion, an operator platform, a load bearing deck portion having a front end and a rear end, and at least two wheels in a rear portion of the vehicle, wherein the deck portion is facing a load area;
a picker cart removably coupled to said stock chaser vehicle, said picker cart having a front and a rear end, and defining a volume above a portion of said vehicle deck for receiving objects picked by an operator, said picker cart further including four wheels each generally attached at one of the corresponding four corners of said cart; and,
a coupling means for secure engagement of said picker cart to said stock chaser vehicle, whereby said picker cart and said stock chaser vehicle are aligned as to substantially share the same travel footprint.

2. The material handling system of claim 1, wherein said four wheels of said order picker cart remain in contact with the ground while being transported with said stock chaser vehicle.

3. The material handling system of claim 1, wherein two wheels at a rear end of said cart are substantially aligned along the same centerline axis of rotation as said at least two rear wheels of said stock chaser vehicle.

4. The material handling system of claim 1, wherein the side-by-side clearance between said stock chaser vehicle and an outer frame of said cart is less than 1.0 inch.

5. The material handling system of claim 4, wherein the side-by-side clearance between said stock chaser vehicle and said outer frame of said cart is approximately 0.5 inches.

6. The material handling system of claim 1, wherein said defined volume of said picker cart includes at least two shelving units.

7. The material handling system of claim 1, wherein said coupling means is located at said front ends of said picker cart and said stock chaser vehicle.

8. The material handling system of claim 1, wherein said picker cart includes at least one handle portion attached to said outer frame.
